(19) United States
(12) Patent Application Publication
(10) Pub. No.: US 2005/0253445 A1
(43) Pub. Date: Nov. 17, 2005

(54) Self propelled trailer

(76) Inventors: Aaron Beiler, Gap, PA (US); Raymond Beiler, Gap, PA (US)

Correspondence Address: BARLEY SNYDER, LLC, 1000 WESTLAKES DRIVE, SUITE 275, BERWYN, PA, 19312, US

(21) Appl. No.: 11/187,296

(22) Filed: Jul. 22, 2005

Related U.S. Application Data
(63) Continuation-in-part of application No. 10/868,274, filed on Jun. 14, 2004, now abandoned.
Application No. 10/868,274 is a continuation of application No. 10/622,629, filed on Jul. 18, 2003, now Pat. No. 6,817,677.
(60) Provisional application No. 60/536,002, filed on Jan. 13, 2004.

(51) Int. Cl. B65F 3/02

(52) U.S. Cl. 298/22 C

(57) ABSTRACT

The apparatus is a self propelled trailer which may include a bin with closed sides and a tailgate for collecting waste material directly as it is stripped from a building and for dumping the material at remote sites. The entire bin can be moved out beyond the rear of the trailer by the use of a hydraulic system. The trailer can be moved under its own power to a tow truck, and the bin can be tilted rearward to dump its load at any site. Optional hinged extensions at the top of the sides are held at an angle sloping into the bin to approximately double the “catch” area of the bin and prevent material from falling to the ground.

### RELATED APPLICATION DATA

This application is a Continuation-In-Part of application Ser. No. 10/868,274, filed on Jun. 14, 2004, which is a Continuation of application Ser. No. 10/622,629, filed on Jul. 18, 2003, now U.S. Pat. No. 6,817,677, which is based on a Provisional Patent Application 60/536,002, filed on Jan. 13, 2004.

### BACKGROUND OF THE INVENTION

This invention deals generally with dumping vehicles and more specifically with a self propelled trailer that has dumping, and rear extension features.

Stripping old material from a building roof in order to put on a new roof is a time consuming and dirty job. It sometimes involves throwing the old material to the ground around the building and then manually picking it up to put it into a disposal container. Even if the material can be thrown directly into a container there remains the problem of getting the container or the material onto a vehicle to move it off the work site. The most common solution to the disposal problem is to move a dump truck adjacent to the building and to attempt to throw the material directly from the roof into the truck bin. Furthermore, the problem is not limited to roofing material. Any building remodeling generates significant construction trash, and the most convenient method of removing it from the building is to throw it out a window.

However, it is not always possible to move a large truck into a location adjacent to a building. Fences, lawns, and shrubs can easily be damaged by any size truck, and it is even more likely when dealing with the typical large dump truck.

It would be very beneficial to have a vehicle that could move around the typical landscaped yard surrounding a building and could place a collection container in a location to collect discarded material without damaging the lawn and plants. Substantially greater benefit would be derived from such a vehicle if it could also haul the material to a disposal site and dump it.

### SUMMARY

The present invention is a towable trailer which is also self propelled by an on board small power source so that it can move within a job site to areas inaccessible to larger vehicles.

The basic structure of the trailer features a towable chassis with a hitch coupler at a first end of the chassis and at least two road wheels located adjacent to a second end of the chassis that is remote from the hitch coupler. At least one steerable front wheel is located adjacent to the first end of the chassis. A power source is mounted upon the chassis and interconnected with the road wheels to power the road wheels and a central control panel supported by the chassis includes controls for controlling the power source and for retracting, lowering and steering the front wheel.

A bin with closed sides and a tailgate, may be mounted on a lift mechanism that can be extended out beyond the rear of the trailer by an extension hydraulic piston that moves sleeve-like beam extensions of the main beams rearward. A pair of support beams pivoting from the beam extensions can be raised by a set of lifting hydraulic pistons so that the front of the support beams can be raised and the bin dumped.

### BRIEF DESCRIPTION OF THE DRAWINGS

FIG. 1 is a schematic side view of the trailer of an embodiment of the invention as it appears when it is ready for towing on roads.

FIG. 2 is a perspective view of the trailer of the embodiment of the invention as it appears when it is it is tilted rearward and extended for dumping.

FIG. 3 is a schematic top view of the trailer of the embodiment of the invention with the bin removed to show the relationship of the various support beams and the locations of the hydraulic pistons when the trailer is road ready.

FIG. 4 is a schematic rear view of the trailer of the embodiment of the invention showing the extension panels opened outward and supported at an angle sloping into the bin by angularly extending chains.

FIG. 5 is a schematic top view of a bin according to an embodiment of the invention showing, showing a scaffold attachment arrangement.

FIG. 6. is a schematic cut away side view of the bin shown in FIG. 5.

FIG. 7. is a schematic side view of an alternate embodiment trailer of the invention with the bin removed.

### DETAILED DESCRIPTION OF THE INVENTION

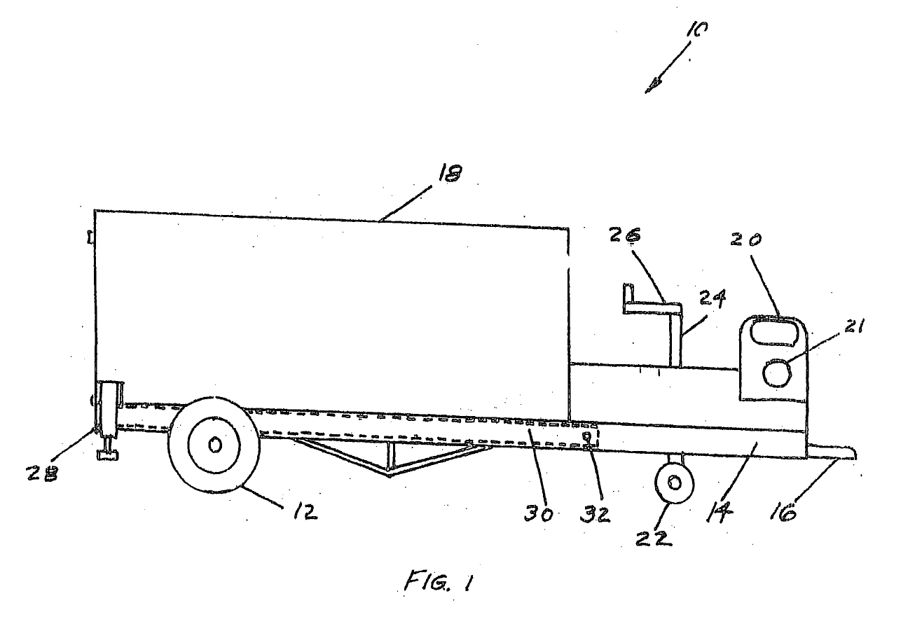

FIG. 1 is a schematic side view of trailer 10 of an embodiment of the invention as it appears when it is ready for towing on roads. As with any conventional road ready trailer, trailer 10 includes rear road wheels 12, one of which is on the opposite side of trailer 10, chassis beams 14, one of which is on the opposite side of trailer 10, and hitch coupler 16.

To accomplish the functions of the invention, trailer 10 also includes bin 18 mounted toward the rear of chassis beams 14, which is used for collection of material and power source 20 which is attached to adjacent conventional hydraulic pump 21 for powering the hydraulic pistons aboard the trailer. Power source 20 can be a small internal combustion engine, a battery powered motor, or even an electric motor operating on line voltage. Power source 20 is interconnected with rear road wheels 12 by conventional means such as chains, belts, or a drive shaft and a transmission so that trailer 10 can be moved around a work site under its own power. Rear wheels 12 can also be powered by a hydraulic motor installed adjacent to the wheels and interconnected to the on board hydraulic pump by hydraulic lines. Regardless of the specific mode of powering rear wheels 12, power source 20 includes conventional controls located on a central control panel 21 for starting, stopping, and regulating its speed. The central control panel 21 is located to include a plurality of controls which may be a series of buttons, levers, or other suitable controls which allow the operator to control retracting and lowering and steering of the front wheels 22, all motions of the bin 18, and power to the rear road wheels 12. From the central control panel 21, an operator can also engage or disengage the power source 20 from the rear wheels. Controls may also optionally be provided on the control panel 21 for controlling certain other features of the trailer 10 such as extension panels 52 which will be described later or the tailgate 60 which will also be described later. An operator stand may optionally be provided in the vicinity of the central control panel 21 allowing an operator to move along with the trailer 10 as he controls its motion. The central control panel 21 therefore provides an operator with the ability to control all features of the trailer 10 from a single location while optionally standing on an operator stand and moving along with the trailer as it travels under its own power. Trailer 10 also includes steerable front wheels 22 for maneuvering the trailer when it is being self propelled. In the embodiment front wheels 22 are a pair of small wheels mounted together on a common axle and steered by direct connection to shaft 24 that is manually turned by lever 26. However, it is a simple matter to include a gear set to reduce the turning effort.

The combination of on board power for rear wheels 12 and steerable front wheels 22 makes it possible to effortlessly move trailer 10 around a work site even when bin 18 is fully loaded.

Trailer 10 also includes conventional hydraulically extendible stabilizer pistons 28 located near at least the rear corners of the trailer. These pistons are extended to ground level to stabilize trailer 10 before bin 18 is used to receive material.

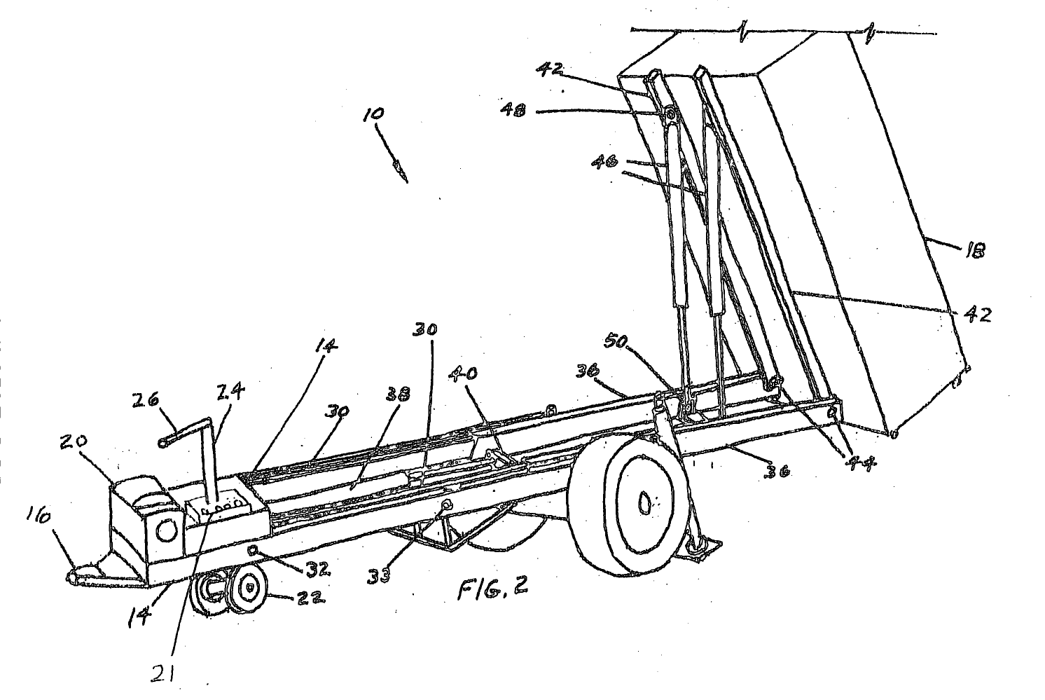

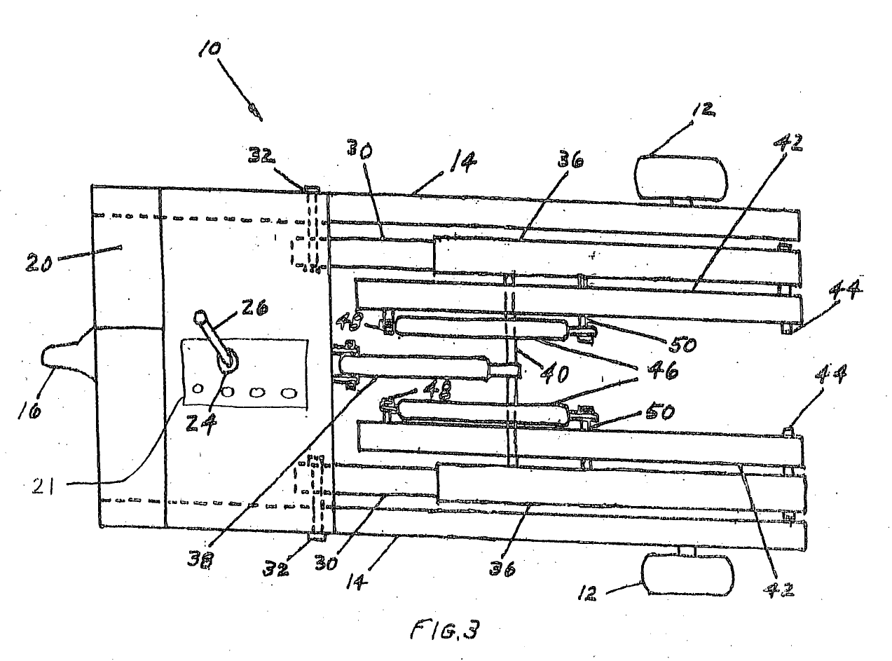

Some of the apparatus to lift and move bin 18 can also be seen in FIG. 1, and these parts can also be seen in FIG. 2 and FIG. 3, the descriptions of which further explain their locations and functions. Main beams 30 (a second one is on the far side of trailer 10) support bin 18 and another set of support beams that are attached directly to the bottom of bin 18. Main beams 30 are attached to chassis beams 14 at points 32 near the front edge of bin 18.

FIG. 2 is a perspective view of trailer 10 of an embodiment of the invention as it appears when it is it is extended and tilted for dumping. Main beams 30 are attached to chassis beams 14 near the front of trailer 10 at points 32. That particular attachment location permits main beams 30 to include sliding extensions 36.

In this embodiment, sliding extensions 36 are constructed as sleeves around main beams 30. Extensions 36 are moved along main beams 30 by hydraulic piston 38 that is attached to cross tie 40 which is attached to both extensions 36. This permits moving extensions 36 straight back.

The ends of extensions 36 are attached to bin support beams 42 upon which bin 18 is mounted. Support beams 42 are attached to and pivot relative to extensions 36 with their pivot points 44 located at the rear ends of both extensions 36 and bin support beams 42. Thus, when the front end of bin 18 is pivoted upward and away from extensions 36, bin 18 takes on an orientation that permits the dumping of the material within bin 18 out the rear of bin 18. The front of bin 18 is pivoted upward by hydraulic pistons 46 that are attached between pivot points 48 near the front end of support beams 42 and pivot points 50 at a location approaching the rear of extensions 36. The extension of hydraulic pistons 46 can be controlled to dump bin 18 at multiple angles when it is either in the road travel position or when it is extended out beyond the rear of trailer 10.

FIG. 3 is a schematic top view of trailer 10 with bin 18 removed to show the beam layout of this embodiment and the relationship of the various support beams and the locations of the hydraulic pistons when trailer 10 is prepared for road travel.

When fully lowered as shown in FIG. 3 all the beams and the hydraulic pistons that operate them are located approximately within the plane of chassis beams 14. Thus, main beams 30 are located adjacent and parallel to chassis beams 14. Extensions 36 are shown fully retracted onto main beams 30, and hydraulic piston 38, which moves them rearward along main beams 30, is located in the center of trailer 10. Piston 38 is connected to extensions 36 by cross tie 40.

Support beams 42 are positioned adjacent and parallel to main beams 30 and are located between main beams 30 and centrally located hydraulic piston 38. Hydraulic pistons 46 that lift support beams 42 are located adjacent to and inboard of their respective beams. The various pivot points for the beams and hydraulic pistons that have been previously described in regard to FIG. 2 are also shown in FIG. 3 when the beams are in their lowered positions.

FIG. 7 is a schematic side view of an alternate lift mechanism 100, wherein the bin, controls, power source, and hydraulics have been removed for clarity. In this alternate embodiment, chassis beams support main beams 130 similar to the embodiment of FIG. 2. It should be understood that the chassis beams have been removed for clarity in the drawing. It should also be understood that the chassis beam may optionally be removed in this embodiment and the main beam may serve their function. Each main beam 130 supports a pair of lift beams 141, 143 at a front pivot point 132 and a rear pivot point 144 respectively. The front lift beam 141 is connected to a support beam 130 at a front lift pivot point 133. Likewise, the support beam 30 is connected to the rear lift beam 143 at a rear lift pivot point 135. As in the embodiment of FIG. 2, the support beam 130 includes optional sliding extensions 136 constructed as sleeves around the support beam 130. Similar to the embodiment of FIG. 2, these extensions 136 are moved along the support beams 130 by a hydraulic piston. It should be understood by those reasonably skilled in the art that the hydraulic piston has been removed from this drawing for clarity. Likewise, a pair of hydraulic pistons like the pistons 46 of the first embodiment may be similarly attached between respective pivot points on each of the lift beams 142, 143. Each of the lift beams 142, 143 may therefore be independently controlled to lift and tilt the main beam 130 and ultimately the bin 18 as desired. FIG. 7 also shows the lift mechanism 100 in a lowered position by phantom lines.

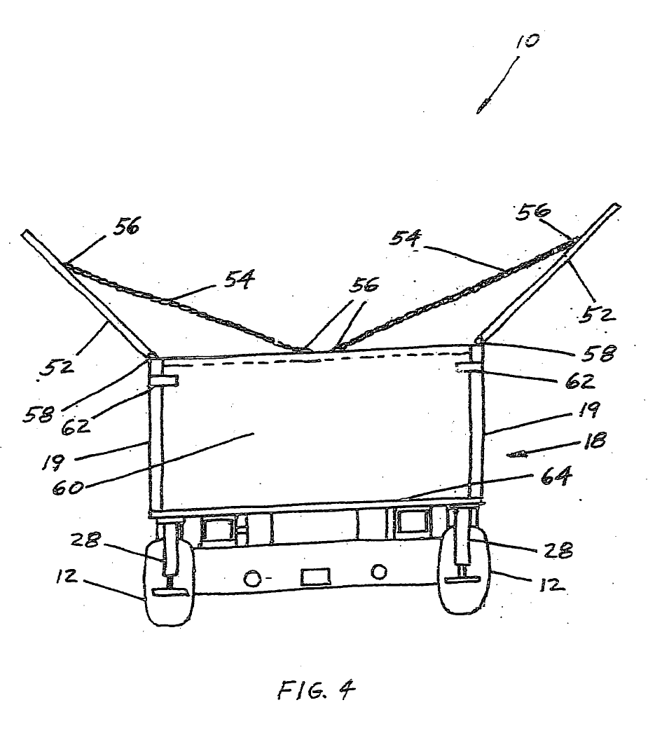

FIG. 4 is a schematic rear view of trailer 10 of the embodiment of the invention showing extension panels 52 which are hingeable mounted to the sides 19 of the bin 18 at a top thereof. They are shown here opened outward and supported at an angle sloping into bin 18 by angularly extending chains 54. When opened at the work site, extension panels 52 approximately double the “catch” area of bin 18 and prevent stray material from falling to the ground. Chains 54 are conventionally anchored to bin 10 and extension panels 52 at anchors 56, and extension panels 52 are conventionally mounted on the top edges of sides 19 of bin 18 with hinges 58.

Tailgate 60 of bin 18 is opened to dump material out of bin 18. To accomplish this, latches 62 are opened, and tailgate 60 is opened and rotated downward on hinge 64.

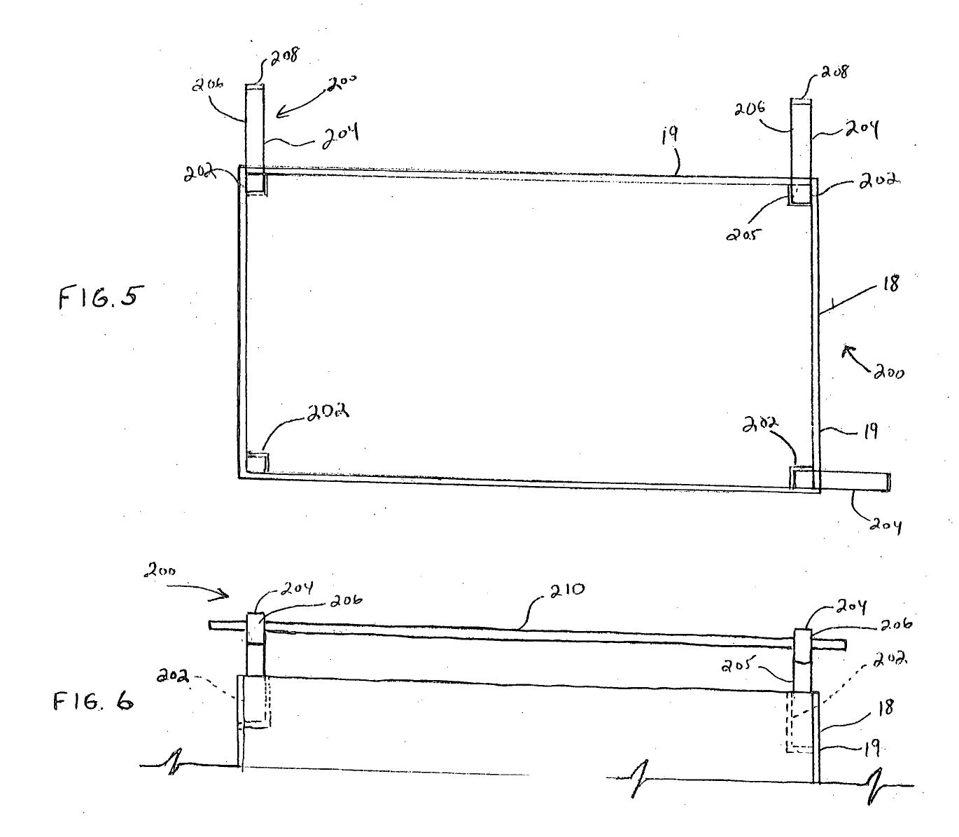

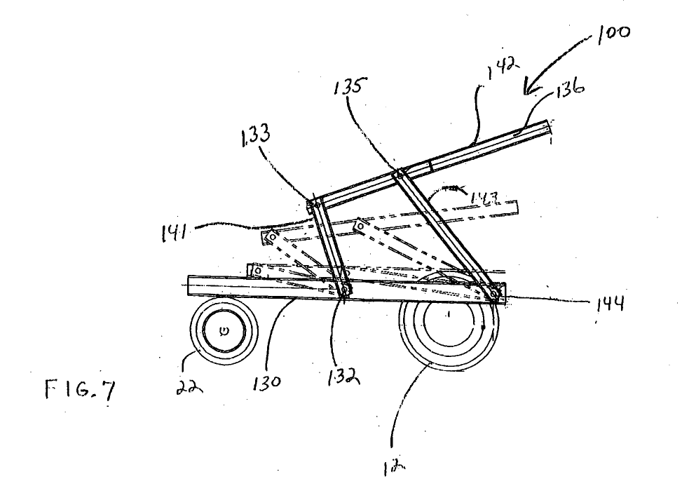

FIGS. 5 and 6 show top and cut away side views of the bin 18 having the extension panels 52 removed for clarity of illustration and having an optional scaffold supporting system 200 applied. The scaffold supporting system 200 include tubular holders 202 which are mounted to sides 19 of the bin 18 near the corners thereof. The tubular holders 202 in this embodiment are shown as having a square tubular profile, however, it should be understood by those reasonably skilled in the art that the profile of the tubular holders 202 may take other shapes such circular in order to be complementary to the scaffold holders 204 which are inserted therein.

The scaffold holders 204 include an upright member 205 which supports an extension 206. Both the upright member 205 and the extension 206 may be formed of a tubular material such as, in this embodiment, a square tubular member which is complementary to the tubular holders 202. The extension 206 extends generally perpendicular to the upright member 205. A small ledge 208 is disposed at a distal end of the extension 206 such that a scaffolding member 210 fits on the extension 206 between the upright member 205 and the small ledge 208. It should be understood that the upright member 205 may be inserted to the tubular holder 202 such that scaffolding members 210 may extend either along the long or short sides 19 of the bin 18. For example, in FIG. 5 the scaffold holder 204 at the lower right side of the drawing is inserted for scaffolding along the short side 19 while the two scaffold holders 204 located along the top of the drawing are inserted for a scaffolding along the long side 19 of the bin 18. This arrangement provides flexibility in allowing for scaffolding on any side 19 of the bin 18. It should understood by those reasonably skilled in the art that this scaffold supporting system 200 may be provided with or without the extension panels 52.

The described structure of the embodiments of trailer 10 thereby furnishes a very versatile vehicle that is both towable and self propelled. It can therefore approach closer to most buildings and provide convenient accumulation of construction waste material while also facilitating moving to and dumping such material directly at disposal sites for final disposal.

The invention advantageously permits a trailer to be towed and then subsequently moved under it's own power. In the case where a bin is mounted on the trailer the invention provides the convenient collection of discarded construction material with a container that can be placed immediately adjacent to the exterior sides of a building. For roof work, it means that the container can be placed below the roof edge and under the roof overhang, and material can be thrown directly from the roof into the bin.

When the bin requires emptying, it is moved under its own power to a tow truck that tows it to the dump site. Then, the tailgate is opened, and the bin may be raised and/or tilted rearward to dump its load. This raising and/or tilting is accomplished simply by operating a lift system lifting and/or extending the set of lifting hydraulic pistons to raise the front of the bin.

The trailer of the present invention thereby makes it possible to collect material from a window, door, or the roof of a building without disturbing the landscaping. In fact, the narrow width of the embodiment of the invention even makes it possible to move the vehicle through a typical gate in a residential fence. Furthermore, it permits dumping the collected material directly from the trailer's collection bin at a dump site, thus eliminating any time consuming transfer.

It is to be understood that the form of this invention as shown are merely embodiments. Various changes may be made in the function and arrangement of parts; equivalent means may be substituted for those illustrated and described; and certain features may be used independently from others without departing from the spirit and scope of the invention as defined in the following claims.

For example, other positions may be used for the various beams and hydraulic cylinders when they are stowed for the trailer's road travel, and other means can be used to support the extension panels when they are deployed. The bin may be removed and the trailer used for other purposes. Alternate lift mechanisms may be used. Furthermore, any conventional power system of self propulsion can be used on the trailer, and additional or fewer hydraulic pistons can be used for each particular application described for the pistons.

1. A trailer for collecting and dumping material comprising:
a towable chassis with a hitch coupler at a first end of the chassis and at least two road wheels located adjacent to a second end of the chassis that is remote from the hitch coupler;
at least one steerable wheel located adjacent to the first end of the chassis with a steering control mechanism interconnected with the steerable wheel;
a power source mounted upon the chassis and interconnected with the road wheels to power the road wheels;
a hydraulic system mounted upon the chassis and including a hydraulic pump interconnected with and powered by the power source;
at least two main beams, each attached to the chassis adjacent to the first end of the chassis with the main beams extending to a location adjacent to the second end of the chassis;
at least two pivoting support beams each attached to a main beam at a pivot point located at a point on a main beam adjacent to the second end of the chassis, with the support beams extending toward the first end of the chassis;
at least one hydraulic piston powered by the hydraulic pump and interconnected with the pivoting support beams and the main beams to lift the ends of the support beams that extend toward the first end of the chassis above the main beams;
movable extensions on the main beams, the extensions having ends movable out beyond the second end of the chassis; and
a bin attached to and supported by the support beams.

2. The trailer of claim 1 wherein the pivot points of the support beams are attached to the extensions adjacent to the ends of the extensions that extend out beyond the second end of the chassis, and the hydraulic pistons that are interconnected with the support beams are also interconnected with the extensions of the main beams.

3. The trailer of claim 2 further including at least one hydraulic piston interconnected with the chassis and the extensions of the main beams to power the movement of the extensions.

4. The trailer of claim 1 wherein the bin includes a tailgate that can be opened.

5. The trailer of claim 1 further including at least two hydraulic stabilizer pistons, one located adjacent to each of the corners at the second end of the chassis.

6. The trailer of claim 1 wherein the chassis includes at least two chassis beams extending from the first end of the chassis to the second end of the chassis.

7. The trailer of claim 1 wherein the bin includes an extension panel being hingeably mounted to the a side of the bin at a top thereof.

8. The trailer of claim 7 further comprising a chain being anchored to the extension panel and the bin.

9. The trailer of claim 1 further comprising a central control panel.

10. The trailer of claim 9 wherein the central control panel includes controls for the power source and the hydraulic system.

11. The trailer of claim 10 wherein the central control panel includes controls for the tailgate.

12. The trailer of claim 11 wherein the central control panel includes the steering control mechanism.

13. A trailer comprising:
a towable chassis with a hitch coupler at a first end of the chassis and at least two road wheels located adjacent to a second end of the chassis that is remote from the hitch coupler;
at least one steerable front wheel located adjacent to the first end of the chassis;
a power source mounted upon the chassis and interconnected with the road wheels to power the road wheels; and,
a central control panel including controls for controlling the power source and for retracting, lowering and steering the front wheel.

14. The trailer of claim 13 further comprising a lift mechanism operatively mounted on the towable chassis.

15. The trailer of claim 14 wherein the lift mechanism includes support beams which are articulated by a hydraulic system operating on a main beam or a lift beam.

16. The trailer of claim 14 further comprising controls located on the central control panel for controlling the hydraulic system.

17. The trailer of claim 16 further comprising a bin being supported on the support beam.

18. The trailer of claim 17 further comprising extensions being slidingly mounted on and extendable from the support beam.

19. The trailer of claim 17 further comprising front and rear lift beams each being connected to a main beam at a respective pivot point.

20. The trailer of claim 19 wherein the front and rear lift beams are pivotally connected to the support beam at ends opposite the respective pivot points.

21. The trailer of claim 17 wherein the bin includes an extension panel being hingeably mounted to the a side of the bin at a top thereof.

22. The trailer of claim 21 further comprising a chain being anchored to the extension panel and the bin.

23. The trailer of claim 17 wherein the bin includes a tailgate that can be opened and controlled by the hydraulic system.
